(19) United States
(12) Patent Application Publication
(10) Pub. No.: US 2004/0248316 A1
(43) Pub. Date: Dec. 9, 2004

(54) Device for use in fluid assay

(76) Inventors: David Alan Percival, Harwarden (GB); David Aubrey Plumptre, Droitwich (GB)

Correspondence Address: HOGAN & HARTSON LLP, ONE TABOR CENTER, SUITE 1500, 1200 SEVENTEENTH ST, DENVER, CO, 80202, US

(21) Appl. No.: 10/488,508

(22) PCT Filed: Sep. 4, 2002
(86) PCT No.: PCT/GB02/04039

(30) Foreign Application Priority Data
Sep. 4, 2001 (GB) 0121340.4

(51) Int. Cl. G01N 31/22

(52) U.S. Cl. 436/165; 422/68.1; 422/58

(57) ABSTRACT

The present invention relates to a device for use in fluid assay, in particular for assaying body fluids such as blood and urine. The device comprises a sample reservoir for a fluid sample to be assayed, the reservoir having an inlet port and an outlet port. The device comprises a fluid sample receiving zone in fluid communication with the reservoir via the inlet port and an excess fluid sample detection zone in fluid communication with the reservoir via the outlet port.

The present invention relates to a device, apparatus and method for use in fluid assay. In particular it relates to a device for use in body fluid assay, for example assays on blood and urine. More particularly, it relates to a device for use m assays for glycated proteins in body fluid samples.

PCT/GB98/03586 discloses an apparatus for conducting an assay comprising a first inlet, a second inlet, and an inlet port, the inlet port being moveable relative to each of the said first and second inlets such that the port can be brought into liquid communication with each inlet in turn as required, the inlet port accommodating a filter means and/or a binder retaining means. In the course of conducting an assay, for example to determine the presence or absence of one or more analytes in a sample, the sample is separated into a first component fraction and a second component fraction, the second component fraction being obtained by eluting a compound held on the binder retaining means.

United Kingdom Patent Application No: 0021887.5 discloses a device for conducting a fluid assay which comprises a carousel mounted on a hub which has an assay component separation zone. The carousel is rotatable about the hub which provides multiple configurations of the device. The carousel has a plurality of chambers which are non-communicating in a first configuration of the device. The device further comprises a first chamber which communicates through the separation zone with at least one other chamber in a second configuration of the device.

U.S. Pat. No. 5,935,858 relates to a device and method for the isolation of one or more components of a sample. The disclosed device includes a reaction chamber, at least one reagent chamber containing a sealed, predetermined amount of reagent, at least one waste chamber, an entry port and a mechanism for moving the reaction chamber sequentially into fluid communication with each of these other components.

U.S. Pat. No. 5,573,951 discloses a multi-chambered blood culture device for simultaneously conducting two blood culture tests on a single blood sample. This disclosure provides an integrated unit with a rotating blood inlet valve assembly for receiving a blood sample simultaneously into two independent sample vials. Independent culture chambers contain growth media, one culture chamber preferably containing an aerobic growth medium and another culture chamber preferably containing an anaerobic growth medium. The device is configured to isolate the sample vials and culture chambers from contaminants of the external environment. By rotating the blood inlet valve assembly, blood is simultaneously released from one sample vile into one culture chamber and from the other sample vial into the other culture chamber.

It is an object of the present invention to provide a device, apparatus and method for use in fluid assay which facilitates measurement of a predetermined quantity of fluid sample to be assayed.

The present invention accordingly provides a device for use in fluid assay comprising a sample reservoir for a fluid sample to be assayed, the reservoir having an inlet port and an outlet port, the device comprising a fluid sample receiving zone in fluid communication with the reservoir via the inlet port and an excess fluid sample detection zone in fluid communication with the reservoir via the outlet port.

The device according to the invention enables a user to dispense accurately and conveniently a predetermined quantity of a fluid sample to be assayed into the reservoir. The known quantity of fluid sample supplied to the reservoir can then be assayed in accordance with known techniques.

In one preferred embodiment of the invention, fluid communication between the fluid sample receiving zone and the reservoir is at least partly achieved by capillary action. In this embodiment of the device according to the invention, an unknown or approximate quantity of fluid sample is supplied to the fluid sample receiving zone and fluid sample is then transferred to the reservoir by means of capillary action, for example through a capillary tube.

In another preferred embodiment of the invention, fluid communication between the fluid sample detection zone and the reservoir is at least partly achieved by capillary action. Thus, as fluid sample is transferred to the reservoir and the reservoir fills up, fluid sample is drawn by capillary action, for example by means of a capillary tube, from the reservoir into the excess fluid sample detection zone.

Preferably, the reservoir has an overflow region and the excess fluid sample detection zone is in fluid communication with the overflow region of the reservoir.

In a further preferred embodiment of the invention, the device has a first configuration in which fluid communication between the reservoir and each of the fluid sample receiving zone and the excess fluid sample detection zone is maintained and a second configuration in which one or each of said fluid communications is broken. In this embodiment, the measured quantity of fluid sample present in the reservoir can be detached from any fluid sample present in the fluid sample receiving zone, the excess fluid sample detection zone or the communicating regions therebetween (including any reservoir overflow region) and then supplied to a fluid assay means, for example the assay device disclosed in United Kingdom Patent Application No: 0021887.5.

In a further preferred embodiment of the invention, the excess fluid sample detection zone is viewable through a lens aperture. The lens aperture may be situated in the device. This provides a ready and convenient means for the operator to detect the presence of excess fluid sample in the excess fluid sample detection zone, the presence of such excess fluid sample indicating that the reservoir is full.

Preferably the reservoir of the device is sized to contain a preselected quantity of the sample to be assayed.

The device according to the invention may be co-operable with drive means for use in automated fluid assay.

The device according to the invention is intended for use in assaying fluid samples, particularly body fluid samples such as blood and urine.

Preferably, the device according to the invention is co-operable with means for assaying the fluid sample, for example means such as those disclosed in co-pending United Kingdom Patent Application No: 0021887.5.

Accordingly, the invention further provides an apparatus for fluid assay comprising a device in accordance with the invention in co-operation with means for assaying the fluid sample.

The invention further provides a method for fluid assay comprising the steps of:

a) supplying a fluid to be assayed to the fluid sample receiving zone of a device in accordance with the invention;

b) detecting excess fluid sample to be assayed in the excess fluid sample detection zone of the device;

c) optionally supplying the fluid sample in the reservoir to a device adapted for assaying the sample; and

d) assaying the fluid sample.

In a particularly preferred embodiment of the invention, there is provided a device in accordance with the invention in co-operation with a further device for effecting fluid assay, the further device comprising a carousel mounted on a hub having an assay component separation zone, the carousel being rotatable about the hub to provide multiple configurations of the further device, the carousel having a plurality of chambers being non-communicating in a first configuration of the firer device, a first chamber communicating through the separation zone with at least one other chamber in a second configuration of the further device. The further device is in accordance with co-pending U.K. Application No: 0021887.5. In this embodiment the hub of the further device may carry the device according to the invention. For example, the device of the invention may comprise a cap carried on the hub of the further device, the cap covering the carousel in use of the device, the cap comprising a reservoir having an inlet port and an outlet port and further comprising a fluid sample receiving zone in fluid communication with the reservoir via the inlet port and an excess fluid sample detection zone in fluid communication with the reservoir via the outlet port.

In a more preferred embodiment of the invention, there is provided a device in accordance with the invention in co-operation with a further device in accordance with co-pending UK Application No. 0021887.5 further comprising a means for breaking an airtight seal disposed in at least one of the chambers.

A specific embodiment of the present invention will now be described with reference to the Figures by way of example only. The embodiment described is in accordance with the last of the preferred embodiments hereinbefore described with suitable adaptation the cap region of the described embodiment, which in itself is in accordance with the invention in its broader aspects, could be used in conjunction with the other types of fluid assay device.

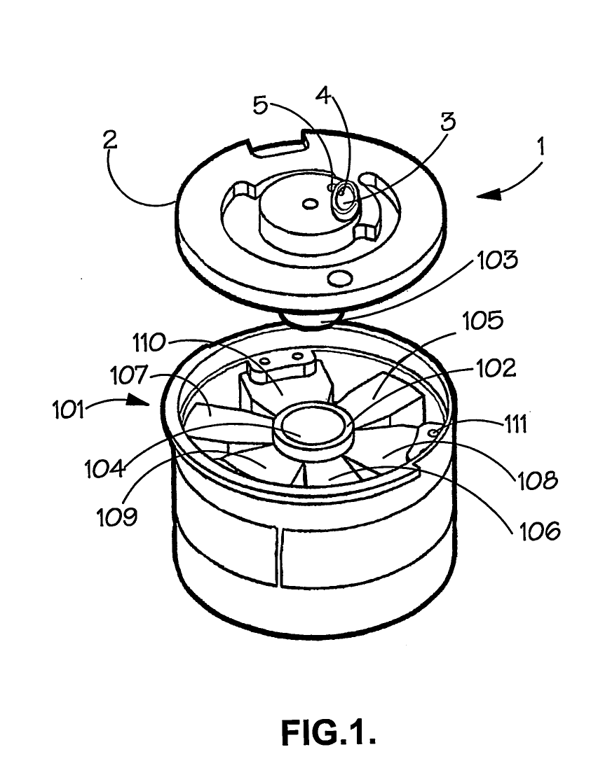

FIG. 1 is a perspective view of a device in accordance with the invention in co-operation with an assay component separation device according to U.K. 0021887.5. The assay component separation device is disassembled in FIG. 1.

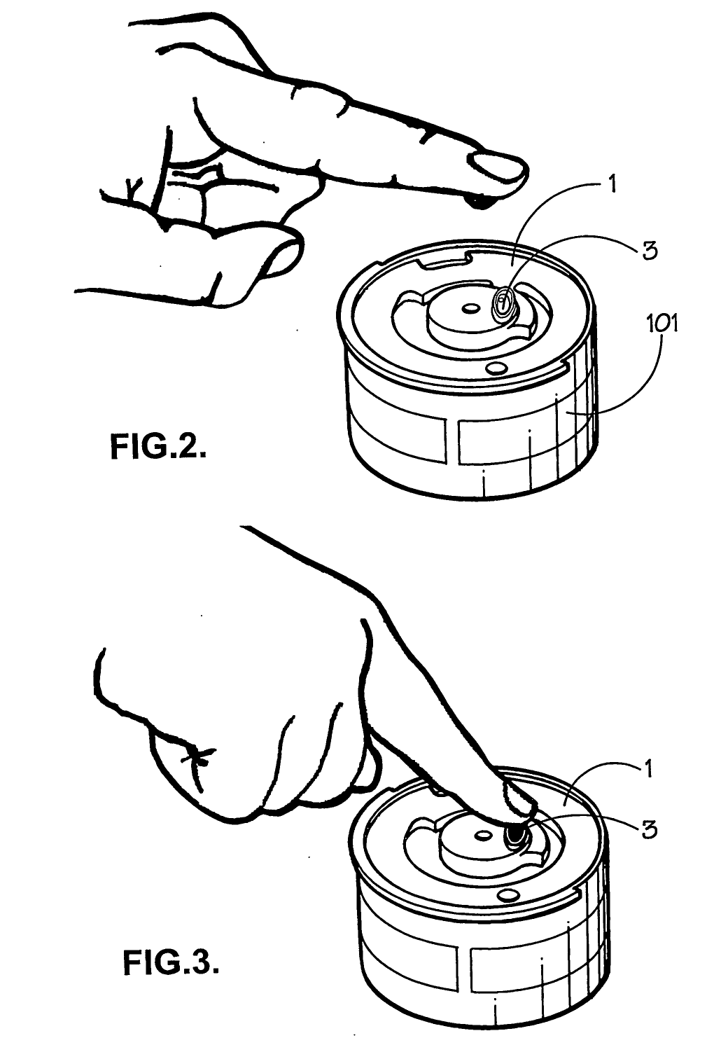

FIG. 2 shows a perspective view of the device of FIG. 1 after assembly of the assay component separation device but before receiving a blood sample to be assayed.

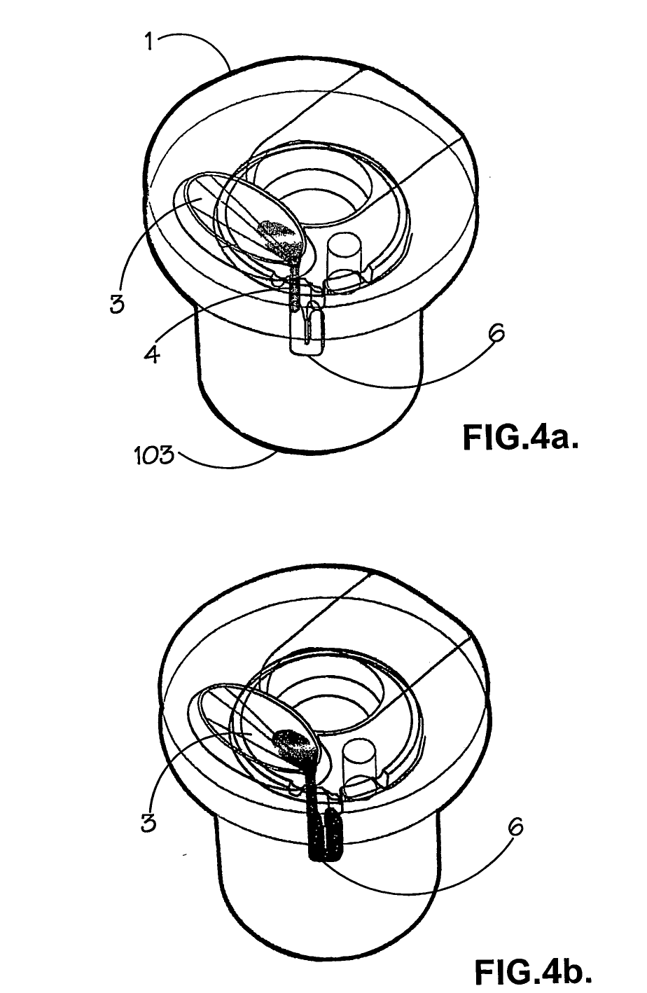

FIG. 3 shows the device of FIG. 2 after supply of the blood to be assayed.

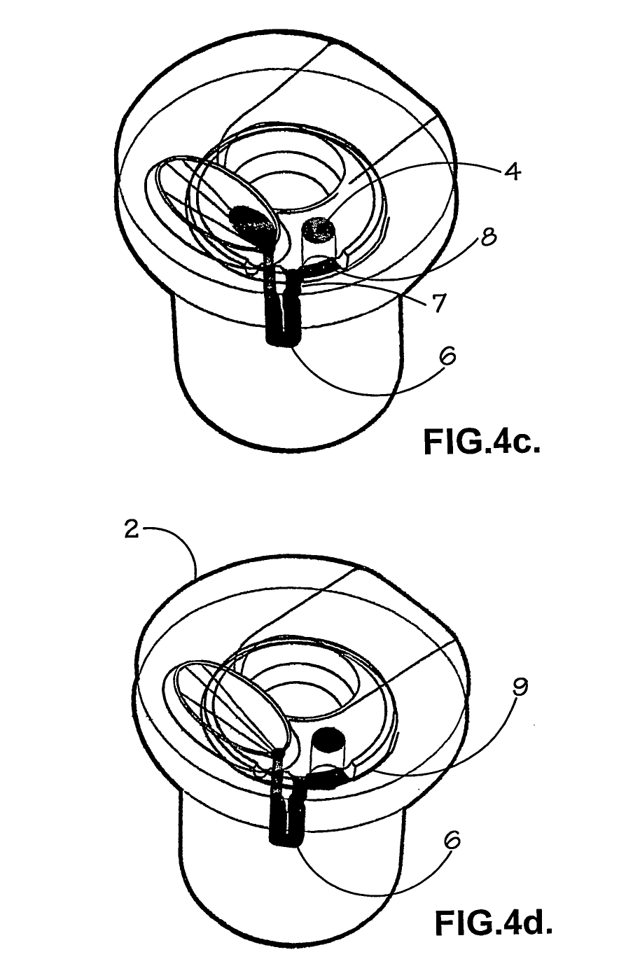

FIG. 4a shows a cut away perspective view of a device in accordance with the invention shortly after supply of body fluid thereto.

FIG. 4b shows the device of FIG. 4a a short time thereafter.

FIG. 4c shows the device of FIG. 4b a short while later.

FIG. 4d shows the device of FIG. 4c a short while later.

Referring to FIG. 1 there is shown a device 1 in accordance with the invention in co-operation with an assay component separation device 101 according to co-pending United Kingdom Patent Application No: 0021887.5

Before describing device 1 in accordance with the invention, the working of assay component separation device 101 will now be briefly described.

Assay component separation device 101 comprises a carousel 102 rotatably mounted on a hub 103 which (when the assay component separation device is assembled, is disposed in a complimentary shaped housing 104. Carousel 102 is divided into a plurality of chambers. There are 3 optical chambers, 105, 106, 107 and 3 reagent chambers 108, 109, 110. The 6 chambers are radially disposed about hub 103 (when assembled) and are arranged into pairs which are disposed diametrically opposite one another. Each pair comprises a reagent chamber and an optical chamber. In the case of an assay for determining glycated and non-glycated hemoglobin the reagent chambers 108, 109, 110 contained respectively:

a) a buffer and an amino phenyl boronate agarose (aPBA) matrix;

b) a wash buffer; and

c) an eluting buffer.

Each chamber pair can be brought into liquid communication via a channel (not shown) disposed in hub 103 when carousel 102 is rotated about hub 103.

In use device 101 is mounted vertically in an apparatus comprising drive means. A sample, for example a blood sample, is loaded in the first reagent chamber 108 via aperture 111 with device 101 in a first configuration in which there is no fluid communication between reagent chamber 108 and its diametrically opposed optical chamber 107. Once aperture 11 has been sealed device 101 is rotated back and forth through 120° to ensure thorough mixing, and in this example to facilitate lysing of the red blood cells thereby liberating the hemoglobin. Device 101 is left for 60-90 seconds during which the glycated hemoglobin present in the sample binds to the aPBA affinity matrix.

Once mixed carousel 102 is held in place such that the first reagent chamber 108 is disposed above the first optical chamber 107 and hub 103 is rotated such that reagent chamber 108 communicates with optical chamber 107 via a tube (not shown), which contains a frit, in hub 103.

The contents of reagent chamber 108 collect in optical chamber 107 which contains the non-glycated hemoglobin present in the original sample. The aPBA affinity matrix collects in the tube frit (not shown) in hub 103.

Hub 103 is then held in place and carousel 102 is rotated a further 60° such that second reagent chamber 109 is brought into liquid communication with optical chamber 105 in a third configuration of device 101. This presents a wash for use and release of non-specifically bound non-glycated hemoglobin from the aPBA affinity matrix bound on the tube frit (not shown) of hub 103.

On rotating carousel 102 by a further 60° the third reagent chamber 110 containing the eluting solution is presented, in a fourth configuration of device 101. The elution buffer removes the glycated hemoglobin from the aPBA affinity matrix and is collected in optical chamber 106 for spectrophotometric analysis.

Referring now to device 1 in accordance with the invention which, in this embodiment, is mounted in hub 103 of device 101, device 1 comprises a cap 2 which, in use of device 1 in co-operation with device 101 covers carousel 102. Device 1 comprises a fluid sample receiving zone 3 which is in fluid communication (not shown in FIG. 1) with a reservoir (also not shown in FIG. 1) by means of a capillary tube 4. Device 1 further comprises a lens aperture 5 for viewing the contents of a excess fluid sample detection zone (not shown in FIG. 1).

FIG. 2 shows device 1 mounted on the hub of device 101 when device 101 is assembled The assembled arrangement is shown prior to the addition of a blood sample to sample receiving zone 3.

FIG. 3 shows a blood sample being supplied to sample receiving zone 3 of device 1.

FIG. 4a shows a partially cut away view of device 1 mounted on hub 103 of a device 101, all of which except for hub 103 is not shown in FIG. 4a, 4b, 4c of 4d. In FIG. 4a a blood fluid sample is shown in sample receiving zone 3 shortly after being supplied thereto. The blood sample is drawn by capillary action through tube 4 into reservoir 6.

FIG. 4b shows the device of FIG. 4a a short while later, at which point reservoir 106 is completely fill. However, the operator cannot yet see this in the device of FIG. 4b because reservoir 6 is, in use of the device, hidden from view.

FIG. 4c shows the device of FIG. 4b a short while later. Overflow from reservoir 6 has been drawn by capillary action through tube 7 into an excess sample detection zone 8 viewable through lens aperture 4. At this stage, the operator is able to detect the presence of excess blood sample through lens aperture 4 and knows that reservoir 6 is completely fill.

In FIG. 4d any further excess blood sample drawn by capillary action from the overflow of reservoir 6 is contained in an overflow well 9.

Once the operator has detected excess fluid sample in zone 8 and thereby knows that reservoir 6 is fill, cap 2 can then be rotated to break the fluid communication between reservoir 6 and capillary tubes 4 and 7. The accurately determined quantity of fluid sample remaining in reservoir 6 can then be supplied to an assay component separation device, for example 101 of FIG. 1 to aperture 111 thereof. An assay procedure can then take place.

1. A device for use in fluid assay comprising a sample reservoir for a fluid sample to be assayed, the reservoir having an inlet port and an outlet port, the device comprising a fluid sample receiving zone in fluid communication with the reservoir via the inlet port and an excess fluid sample detection zone in fluid communication with the reservoir via the outlet port.

2. A device according to claim 1 wherein fluid communication between the fluid sample receiving zone and the reservoir is at least partly achieved by capillary action.

3. A device according to claim 1 wherein fluid communication between the fluid sample detection zone and the reservoir is at least partly achieved by capillary action.

4. A device according to claim 1 wherein the reservoir has an overflow region and the excess fluid sample detection zone is in fluid communication with the overflow region of the reservoir.

5. A device according to claim 1 having a first configuration in which fluid communication between the reservoir and each of the fluid sample receiving zone and the excess fluid sample detection zone is maintained and a second configuration in which one or each of said fluid communications is broken.

6. A device according to claim 1 wherein the excess fluid sample detection zone is viewable through a lens aperture.

7. A device according to claim 1 wherein the reservoir is sized to contain a pre-selected quantity of the sample to be assayed.

8. A device according to claim 1 which is co-operable with drives means for use in automated fluid assay.

9. A device according to claim 1 for use in assaying body fluid samples such as blood and urine.

10. A device according to claim 1 which is co-operable with means for assaying the fluid sample.

11. An apparatus for fluid assay comprising a device in accordance with claim 1 in co-operation with means for assaying the fluid sample.

12. A method for fluid assay comprising the steps of:
a) supplying a fluid to be assayed to the fluid sample receiving zone of a device comprising:
a sample reservoir for the fluid sample to be assayed, the reservoir having an inlet port and an outlet port,
the fluid sample receiving zone in fluid communication with the reservoir via the inlet port, and
an excess fluid sample detection zone in fluid communication with the reservoir via the outlet port;
b) detecting excess fluid sample to be assayed in the excess fluid sample detection zone of the device;
c) optionally supplying the fluid sample in the reservoir to a device adapted for assaying the sample; and
d) assaying the sample.

13. The method for fluid assay of claim 12, wherein communication between the fluid sample receiving zone and the reservoir is at least partly achieved by capillary action.

14. The method for fluid assay of claim 12, wherein fluid communication between the fluid sample detection zone and the reservoir is at least partly achieved by capillary action.

15. The method for fluid assay of claim 12, wherein the reservoir has an overflow region and the excess fluid sample detection zone is in fluid communication with the overflow region of the reservoir.

16. The method for fluid assay of claim 12, wherein the device has a first configuration in which fluid communication between the reservoir and each of the fluid sample receiving zone and the excess fluid sample detection zone is maintained and a second configuration in which at least one of said fluid communications is broken.

17. The method for fluid assay of claim 12, wherein the excess fluid sample detection zone is viewable through a lens aperture.

18. The method for fluid assay of claim 12, wherein the reservoir is sized to contain a pre-selected quantity of the sample to be assayed.

19. The method for fluid assay of claim 12, wherein the device is co-operable with drives means for use in automated fluid assay.

20. The method for fluid assay of claim 12, wherein the device is for use in assaying body fluid samples.
